(19) United States
(12) Patent Application Publication
(10) Pub. No.: US 2013/0300602 A1
(43) Pub. Date: Nov. 14, 2013

(54) ANTENNA ARRAYS WITH CONFIGURABLE POLARIZATIONS AND DEVICES INCLUDING SUCH ANTENNA ARRAYS

(71) Applicant: SAMSUNG ELECTRONICS CO., LTD., Suwon-si (KR)

(72) Inventors: Hongyu Zhou, Richardson, TX (US); Farshid Aryanfar, Allen, TX (US)

(73) Assignee: Samsung Electronics Co., Ltd., Suwon-si (KR)

(21) Appl. No.: 13/861,221

(22) Filed: Apr. 11, 2013

Related U.S. Application Data
(60) Provisional application No. 61/644,151, filed on May 8, 2012.

(51) Int. Cl. H01Q 3/24; H01Q 3/36

(52) U.S. Cl. CPC H01Q 3/247; H01Q 3/36
USPC 342/372

(57) ABSTRACT

An apparatus includes an antenna array having multiple antenna elements arranged in multiple sub-arrays. The antenna elements are arranged in at least two different types of sub-arrays. The at least two different types of sub-arrays have substantially orthogonal electric field (E-field) orientations. The antenna elements can be arranged in multiple patch sub-arrays and multiple substrate integrated waveguide (SIW) sub-arrays, and the patch sub-arrays can be interleaved with the SIW sub-arrays. Each patch sub-array can include at least two patch antenna elements coupled in series, and each SIW sub-array can include a conductive plate and multiple slots in the conductive plate. The SIW sub-arrays can resonate at substantially a same frequency as the patch sub-arrays.

### CROSS-REFERENCE TO RELATED APPLICATION AND PRIORITY CLAIM

This application claims priority under 35 U.S.C. §119(e) to U.S. Provisional Patent Application No. 61/644,151 filed on May 8, 2012, which is hereby incorporated by reference in its entirety.

### TECHNICAL FIELD

This disclosure relates generally to wireless communications. More specifically, this disclosure relates to antenna arrays with configurable polarizations and devices including such antenna arrays.

### BACKGROUND

Antenna arrays or parabolic/dish antennas are often used in millimeter-wave communication systems to achieve a high gain in order to support wireless communications. This is often necessary or desirable since there is typically a relatively high path loss between two points. For satellite systems, parabolic antennas are often used due to their relatively low cost and ease of achieving circular polarization. For radar and direct finding systems, antenna arrays are often used due to their superior scanning capabilities. However, the scanning angle, polarization purity, and polarization diversity of an antenna array are often highly constrained by the choice of antenna elements and the number of feeding phase shifters in the array.

In the next generation of cellular communication systems, the use of millimeter-wave communications is highly likely due to the lack of available spectrum at lower frequencies. In these types of systems, to establish stable signal paths between mobile devices and base stations, high-gain antenna arrays are likely to be mandatory in order to compensate for link losses and reduce power consumption at both ends. To minimize losses due to polarization mismatches between mobile devices and base stations, circular polarization (CP) or dual linear polarization (LP) can be used in the base stations' antenna arrays.

### SUMMARY

This disclosure provides antenna arrays with configurable polarizations and devices including such antenna arrays.

In a first embodiment, an apparatus includes an antenna array having multiple antenna elements arranged in multiple sub-arrays. The antenna elements are arranged in at least two different types of sub-arrays. The at least two different types of sub-arrays have substantially orthogonal electric field (E-field) orientations.

In a second embodiment, a system includes an antenna array having multiple antenna elements arranged in multiple sub-arrays. The antenna elements are arranged in at least two different types of sub-arrays. The at least two different types of sub-arrays have substantially orthogonal electric field (E-field) orientations. The system also includes a transceiver configured to communicate wirelessly via the antenna.

In a third embodiment, a method includes transmitting outgoing wireless signals and/or receiving incoming wireless signals using an antenna array. The antenna array includes multiple antenna elements arranged in multiple sub-arrays. The antenna elements are arranged in at least two different types of sub-arrays. The at least two different types of sub-arrays have substantially orthogonal electric field (E-field) orientations.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. A controller may be implemented in hardware or in a combination of hardware and firmware and/or software. It should be noted that the functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. Definitions for certain other words and phrases are provided throughout this patent document, and those of ordinary skill in the art should understand that in many if not most instances, such definitions apply to prior as well as future uses of such defined words and phrases.

### BRIEF DESCRIPTION OF THE DRAWINGS

For a more complete understanding of this disclosure, reference is now made to the following description, taken in conjunction with the accompanying drawings, in which:

FIG. 1 illustrates an example wireless network according to this disclosure;

FIG. 2 illustrates an example eNodeB according to this disclosure;

FIG. 3 illustrates an example user equipment according to this disclosure; and

FIGS. 4 through 17B illustrate an example antenna array with a configurable polarization and related details according to this disclosure.

### DETAILED DESCRIPTION

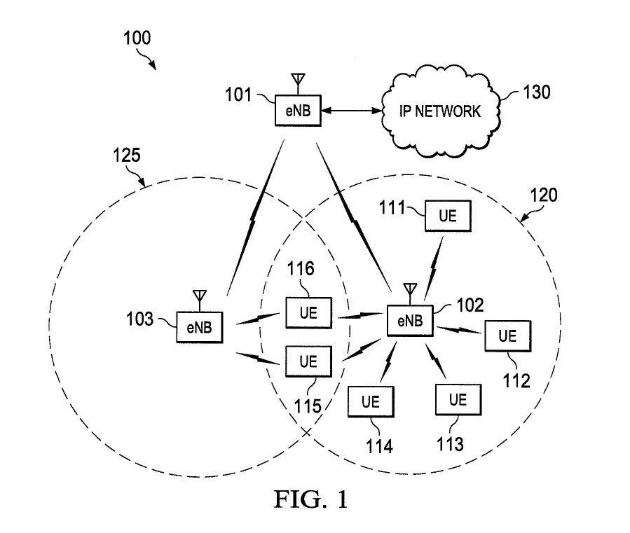

FIGS. 1 through 17B, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example wireless network 100 according to this disclosure. As shown in FIG. 1, the wireless network 100 includes an eNodeB (eNB) 101, an eNB 102, and an eNB 103. The eNB 101 communicates with the eNB 102 and eNB 103. The eNB 101 also communicates with an Internet Protocol (IP) network 130, such as the Internet, a proprietary IP network, or other data network. The eNB 102 and the eNB 103 are able to access the network 130 via the eNB 101 in this example.

The eNB 102 provides wireless broadband access to the network 130 (via the eNB 101) to user equipment (UE) within a coverage area 120 of the eNB 102. The UEs here include UE 111, which may be located in a small business; UE 112, which may be located in an enterprise; UE 113, which may be located in a WiFi hotspot; UE 114, which may be located in a first residence; UE 115, which may be located in a second residence; and UE 116, which may be a mobile device (such as a cell phone, wireless laptop computer, or wireless personal digital assistant). Each of the UEs 111-116 may represent a mobile device or a stationary device. The eNB 103 provides wireless broadband access to the network 130 (via the eNB 101) to UEs within a coverage area 125 of the eNB 103. The UEs here include the UE 115 and the UE 116. In some embodiments, one or more of the eNBs 101-103 may communicate with each other and with the UEs 111-116 using LTE or LTE-A techniques.

Dotted lines show the approximate extents of the coverage areas 120 and 125, which are shown as approximately circular for illustration and explanation only. The coverage areas 120 and 125 may have other shapes, including irregular shapes, depending upon factors like the configurations of the eNBs and variations in radio environments associated with natural and man-made obstructions.

Depending on the network type, other well-known terms may be used instead of “eNodeB” or “eNB” for each of the components 101-103, such as “base station” or “access point.” For the sake of convenience, the terms “eNodeB” and “eNB” are used here to refer to each of the network infrastructure components that provides wireless access to remote wireless equipment. Also, depending on the network type, other well-known terms may be used instead of “user equipment” or “UE” for each of the components 111-116, such as “mobile station” (MS), “subscriber station” (SS), “remote terminal” (RT), “wireless terminal” (WT), and “user device.” For the sake of convenience, the terms “user equipment” and “UE” are used here to refer to remote wireless equipment that wirelessly accesses an eNB, whether the UE is a mobile device (such as a cell phone) or is normally considered a stationary device (such as a desktop computer or vending machine).

As described in more detail below, one or more eNBs 101-103 and/or one or more UEs 111-116 could each include an antenna array with a configurable polarization. The antenna array includes different types of antenna elements or sub-arrays having substantially orthogonal E-field orientations. For example, the antenna array could include patch antenna elements interleaved with substrate integrated waveguide (SIW) antenna elements.

Patch antennas have been used in Kₐ-band antenna arrays, meaning antenna arrays that communicate in the frequency range from about 26.5 GHz to about 40 GHz. However, when used in these types of arrays, patch antennas can suffer from various issues. For example, patch antennas in Kₐ-band arrays often suffer from poor circular polarization performance, lack scanning capabilities, and require the use of multi-layer high-performance printed circuit boards (PCBs). They can also suffer from mutual coupling between antenna elements, and their inherent linear polarization further degrades their effective gain at scanning angles due to polarization mismatches. To obtain circular polarization using patch arrays, sub-arrays can be formed by rotating different patch elements or by using exotic patch shapes and feeding networks. However, using sub-arrays with rotated patch elements can significantly reduce the scanning range of an array due to the large electrical size of the sub-arrays. Using exotic patch shapes and feeding networks can cause an array to have a very small axial ratio bandwidth and may necessitate the use of at least three PCB layers to function properly, which increases production costs.

Alternative PCB-based antenna array configurations include using slots cut in substrate integrated waveguides (SIWs). However, antenna arrays designed using slots in substrate integrated waveguides inherently have a linear polarization. Employing them to achieve circular polarization results in limited scanning capabilities and additional resistive loadings.

In size- and cost-constrained platforms such as consumer electronic devices, planar antenna arrays are often used since they are compatible with standard PCB fabrication techniques and can be easily integrated with other components. Such antenna arrays can be capable of scanning to track mobile users, and sub-array configurations can be used to reduce the number of transmit/receive chains in the devices. Antenna arrays formed using different types of antenna elements or sub-arrays having substantially orthogonal E-field orientations can satisfy all of these criteria while reducing or eliminating the problems associated with conventional approaches that use only patch antenna elements or only SIW antenna elements.

Although FIG. 1 illustrates one example of a wireless network 100, various changes may be made to FIG. 1. For example, the network 100 could include any number of eNBs and any number of UEs in any suitable arrangement. Also, the eNB 101 could communicate directly with any number of UEs and provide those UEs with wireless broadband access to the network 130. Further, the eNB 101 could provide access to other or additional external networks, such as an external telephone network. In addition, the makeup and arrangement of the wireless network 100 is for illustration only. The antenna arrays described below could be used in any other suitable device or system that engages in wireless communications.

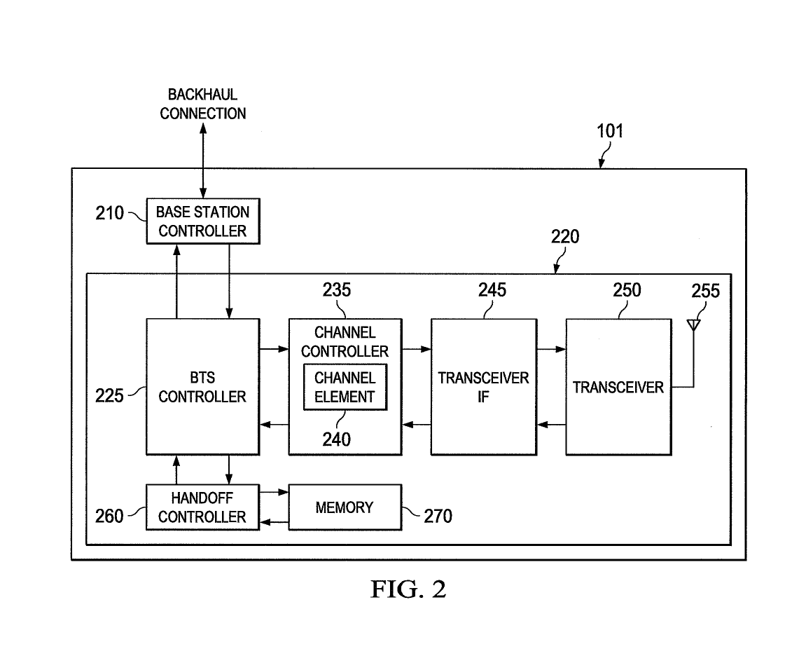

FIG. 2 illustrates an example eNodeB 101 according to this disclosure. The same or similar structure could be used in the eNBs 102-103 of FIG. 1. As shown in FIG. 2, the eNB 101 includes a base station controller (BSC) 210 and one or more base transceiver subsystems (BTSs) 220. The BSC 210 manages the resources of the eNB 101, including the BTSs 220. Each BTS 220 includes a BTS controller 225, a channel controller 235, a transceiver interface (IF) 245, an RF transceiver 250, and an antenna array 255. The channel controller 235 includes a plurality of channel elements 240. Each BTS 220 may also include a handoff controller 260 and a memory 270, although these components could reside outside of a BTS 220.

The BTS controller 225 includes processing circuitry and memory capable of executing an operating program that communicates with the BSC 210 and controls the overall operation of the BTS 220. Under normal conditions, the BTS controller 225 directs the operation of the channel controller 235, where the channel elements 240 perform bi-directional communications in forward channels and reverse channels. The transceiver IF 245 transfers bi-directional channel signals between the channel controller 240 and the RF transceiver 250. The RF transceiver 250 (which could represent integrated or separate transmitter and receiver units) transmits and receives wireless signals via the antenna array 255. The antenna array 255 transmits forward channel signals from the RF transceiver 250 to UEs in the coverage area of the eNB 101. The antenna array 255 also sends to the transceiver 250 reverse channel signals received from the UEs in the coverage area of the eNB 101.

As described below, the antenna array 255 of the eNB 101 can include different types of antenna elements or sub-arrays having substantially orthogonal E-field orientations. Among other things, the antenna array 255 can support the use of millimeter-wave (MMW) antennas, including scanning antennas. Moreover, the antenna array 255 could be manufactured using standard PCB fabrication techniques.

Although FIG. 2 illustrates one example of an eNB 101, various changes may be made to FIG. 2. For example, various components in FIG. 2 could be combined, further subdivided, or omitted and additional components could be added according to particular needs. Also, while FIG. 2 illustrates the eNB 101 operating as a base station, eNBs could be configured to operate as other types of devices (such as an access point).

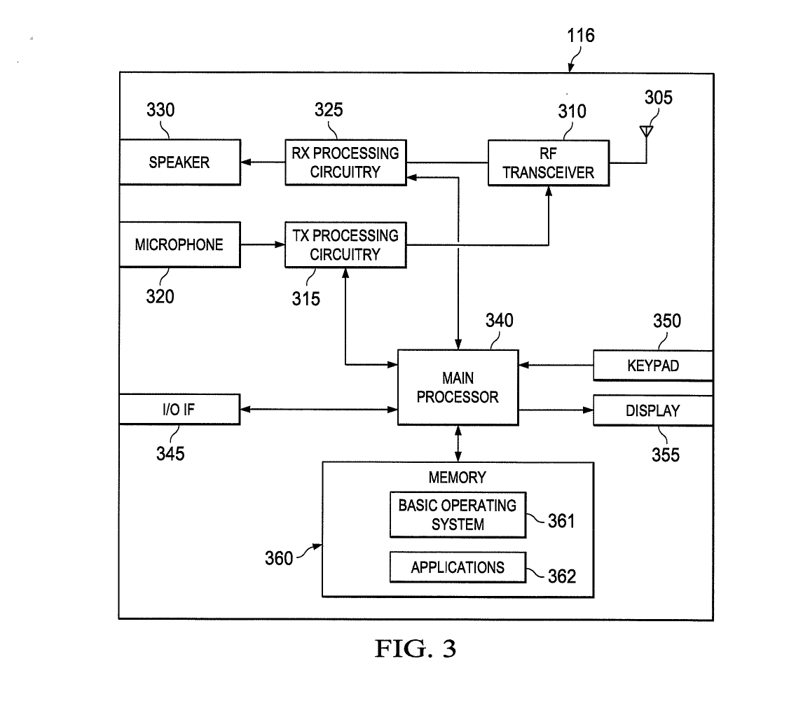

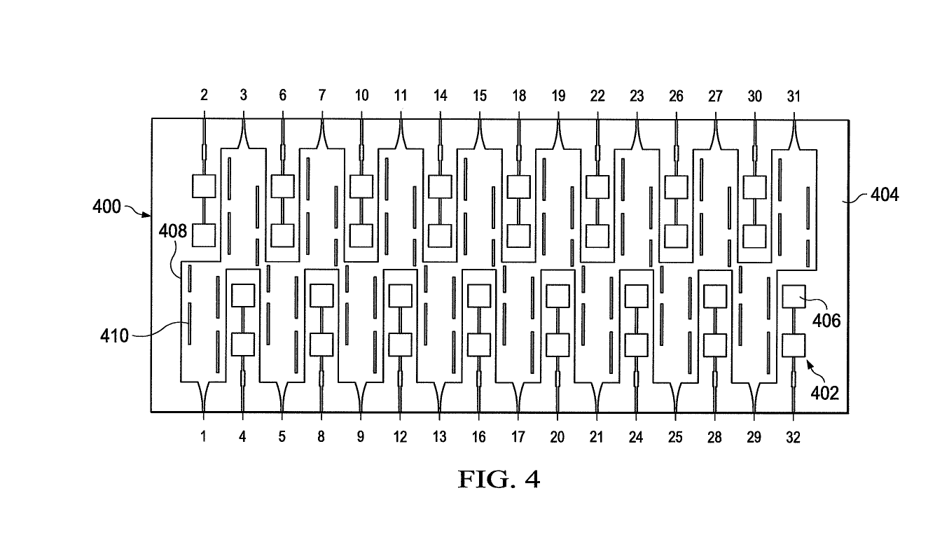

FIG. 3 illustrates an example UE 116 according to this disclosure. The same or similar structure could be used in the UEs 111-116 of FIG. 1. As shown in FIG. 3, the UE 116 includes an antenna 305, an RF transceiver 310, transmit (TX) processing circuitry 315, a microphone 320, and receive (RX) processing circuitry 325. The UE 116 also includes a speaker 330, a main processor 340, an input/output (I/O) interface 345, a keypad 350, a display 355, and a memory 360. The memory 360 includes a basic operating system (OS) program 361 and one or more applications 362. The applications 362 can support various functions, such as voice communications, web browsing, productivity applications, and games.

The RF transceiver 310 receives, from the antenna 305, an incoming RF signal transmitted by an eNB. The RF transceiver 310 down-converts the incoming RF signal to generate an intermediate frequency (IF) signal or a baseband signal. The IF or baseband signal is sent to the RX processing circuitry 325, which generates a processed baseband signal (such as by filtering, decoding, and/or digitizing the baseband or IF signal). The RX processing circuitry 325 can transmit the processed baseband signal to, for example, the speaker 330 (such as for voice data) or to the main processor 340 for further processing (such as for web browsing data).

The TX processing circuitry 315 receives analog or digital voice data from the microphone 320 or other outgoing baseband data (such as web, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The main processor 340 executes the basic OS program 361 in order to control the overall operation of the UE 116. For example, the main processor 340 can control the reception of forward channel signals and the transmission of reverse channel signals by the RF transceiver 310, RX processing circuitry 325, and TX processing circuitry 315 in accordance with well-known principles.

The main processor 340 is also capable of executing other processes and programs, such as the applications 362. The main processor 340 can execute these applications 362 based on various inputs, such as input from the OS program 361, a user, or an eNB. In some embodiments, the main processor 340 is a microprocessor or microcontroller. The memory 360 can include any suitable storage device(s), such as a random access memory (RAM) and a Flash memory or other read-only memory (ROM).

The main processor 340 is coupled to the I/O interface 345. The I/O interface 345 provides the UE 116 with the ability to connect to other devices, such as laptop computers and handheld computers. The I/O interface 345 is the communication path between these accessories and the main processor 340. The main processor 340 is also coupled to the keypad 350 and the display unit 355. The operator of the UE 116 uses the keypad 350 to enter data into the UE 116. The display 355 may be a liquid crystal display capable of rendering text and/or at least limited graphics from web sites. Other embodiments may use other types of displays, such as touchscreen displays that can also receive user input.

As described below, the antenna 305 of the UE 116 can include an antenna array, which includes different types of antenna elements or sub-arrays having substantially orthogonal E-field orientations. Among other things, the antenna 305 could represent a MMW antenna, including a scanning antenna. Moreover, the antenna 305 could be manufactured using standard PCB fabrication techniques.

Although FIG. 3 illustrates one example of a UE 116, various changes may be made to FIG. 3. For example, various components in FIG. 3 could be combined, further subdivided, or omitted and additional components could be added according to particular needs. Also, while FIG. 3 illustrates the UE 116 operating as a mobile telephone, UEs could be configured to operate as other types of mobile or stationary devices.

FIGS. 4 through 17B illustrate an example antenna array 400 with a configurable polarization and related details according to this disclosure. As shown in FIG. 4, the antenna array 400 includes two types of sub-arrays, namely patch sub-arrays 402 and SIW sub-arrays 404 that are interleaved with one another. Each patch sub-array 402 generally includes multiple series-coupled patch elements 406, each of which represents a flat “patch” of conductive material (typically square or rectangular) separated from a larger conductive “ground plane.” Each SIW sub-array 404 generally includes a slotted substrate integrated waveguide. A substrate integrated waveguide represents a region where a conductive plate 408 is separated from the ground plane, and rows of vias filled with conductive material are formed between the conductive plate 408 and the ground plane. The plates 408 in the SIW sub-arrays 404 are modified to include various slots 410.

By periodically interleaving these two types of sub-arrays 402-404, consistent axial ratio and various polarizations can be achieved in the array 400. In general, the antenna array 400 can include any number of series-fed patch sub-arrays 402 interleaved with any number of slotted SIW sub-arrays 404. The use of these sub-arrays 402-404 allows the array 400 to obtain circular polarization (CP) or dual linear polarization (LP) radiation with a single-layer PCB construction. Moreover, instantaneous dual-circular and dual-linear polarizations can be obtained using different input phase combinations, meaning the phases of signals provided to input ports #1-#32 in FIG. 4 can be adjusted to obtain suitable CP or dual LP operation. Simultaneous dual-linear polarization dual-beam radiations can also be realized by phasing the patch sub-arrays 402 and the SIW sub-arrays 404 separately.

The patch elements 406 of the patch sub-arrays 402 and the conductive plates 408 of the SIW sub-arrays 404 could be formed from any suitable material(s), such as one or more metals or other conductive material(s). Also, the patch elements 406 of the patch sub-arrays 402 and the conductive plates 408 of the SIW sub-arrays 404 could be formed in any suitable manner, such as by depositing and etching the conductive material(s) into the appropriate forms. The slots 410 could also be formed in any suitable manner, such as by etching the plates 408 (during the same etching used to fabricate the plates 408 or during a separate etching). Further, the patch elements 406 of the patch sub-arrays 402 and the conductive plates 408 of the SIW sub-arrays 404 could be formed during the same fabrication steps or during different fabrication steps. In addition, the patch elements 406 of the patch sub-arrays 402 and the conductive plates 408 of the SIW sub-arrays 404 could each have any suitable size and shape.

The antenna array 400 could also include any suitable number of each sub-array 402-404. In this particular example, there are sixteen patch sub-arrays 402 and sixteen SIW sub-arrays 404, with a periodic interleaving of the sub-arrays 402-404. However, any other suitable number of each sub-array 402-404 could be used, and any other suitable arrangement of the sub-arrays 402-404 could be used.

The antenna array 400 here uses two different types of antenna elements to achieve substantially orthogonal E-fields in the array electrically rather than physically. The different types of antenna elements can be interleaved, in line aligned, periodically arranged in circles, or placed in any other suitable configuration. The array 400 can be used to provide instantaneous LP and CP beams, where the CP beam can be configured to create either left-hand circular polarization (LHCP) or right-hand circular polarization (RHCP) by simple phase shifts in the feed-lines that provide signals to the ports of the sub-arrays 402-404. The array 400 can also be used to provide two separated dual-LP beams, where the two beams can be controlled independently. Only a single substrate layer may be needed for fabrication of the array 400, enabling the use of standard single-layer PCB fabrication techniques and reducing costs. Moreover, the antenna elements in the sub-arrays 402-404 can experience a reduced or minimized amount of coupling due to the orthogonal modes between the elements. Beyond that, no redundant feeding network may be needed to achieve CP radiation as array elements can be directly connected to phase shifters, and a good axial ratio can be maintained throughout the scanning scope. Finally, a sub-array can be used collectively as a single element in the antenna structure to reduce the number of transmit/receive chains used with the antenna structure.

Each port #1-#32 in FIG. 4 represents any suitable structure for coupling an antenna sub-array to an external device or system. Each port #1-#32 could simply represent a signal line that is capable of being electrically coupled to a phase shifter or other external device or system. In this example, there are thirty-two ports, although this number can vary depending on the number of sub-arrays 402-404 used in the array 400.

Note that although various portions of this disclosure describe the use of the antenna array 400 in the context of supporting communications in millimeter-wave (MMW) frequencies, the array 400 could be used in any other suitable communication spectrum(s), such as with radio signals having frequencies of about 100 MHz to about 300 GHz or extremely low frequencies. Also note that in FIG. 4, the conductive plates 408 of the SIW sub-arrays 404 are coupled together at their corners. This is for illustration only. One or more of the conductive plates 408 in the SIW sub-arrays 404 could represent individual structures that are not coupled to other conductive plates 408 in other SIW sub-arrays 404.

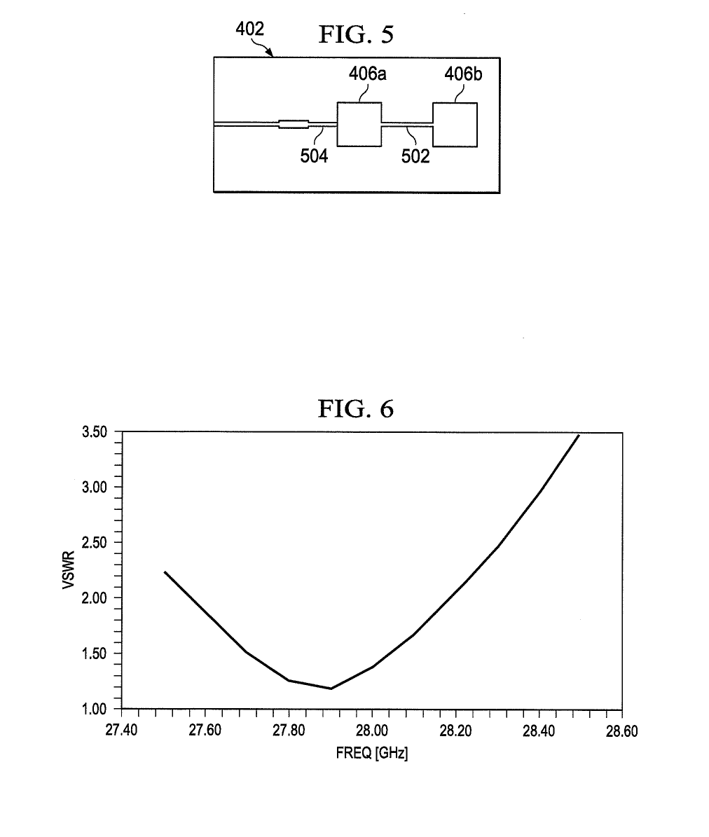

FIG. 5 illustrates an example embodiment of the patch sub-arrays 402. Two patch elements 406a-406b are serially connected via a microstrip transmission line 502. The microstrip line 502 could have a length that is equal to a half-wavelength of a communication frequency. A feeding line 504 is coupled to the patch element 406a, providing excitation for the sub-array 402. The feeding line 504 here includes an impedance transformer, which has the form of a varying width across the feeding line 504. The feeding line 504 could be coupled to any suitable external device or system, such as a phase shifter. Each of the lines 502-504 could be formed from any suitable conductive material(s) and in any suitable manner.

When the electrical lengths of the two patch elements 406a-406b and the microstrip line 502 are half-wavelength, a standing wave is established between the patch elements 406a-406b when a radio frequency (RF) signal is applied. As a result, energy radiates into free space from the patch elements. FIG. 6 shows the voltage standing wave ratio (VSWR) in full-wave simulation for the patch sub-array 402. As can be seen in FIG. 6, good bandwidth can be obtained for VSWR values less than two.

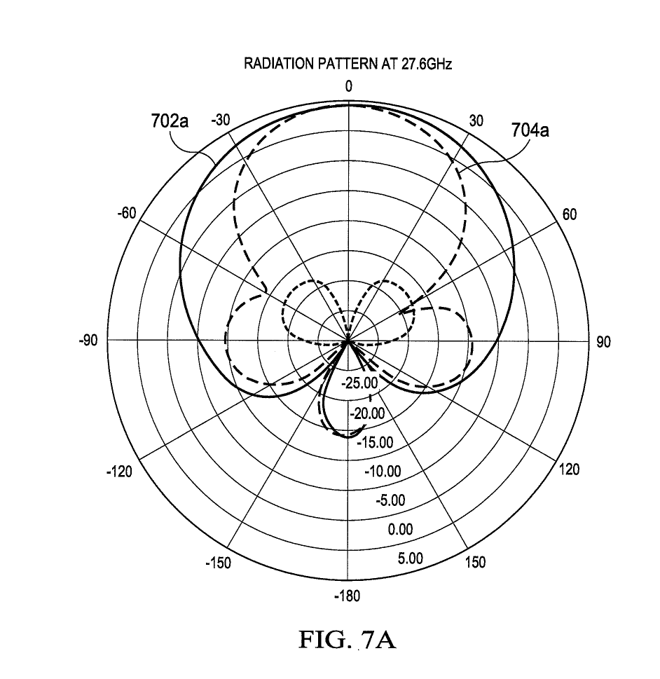

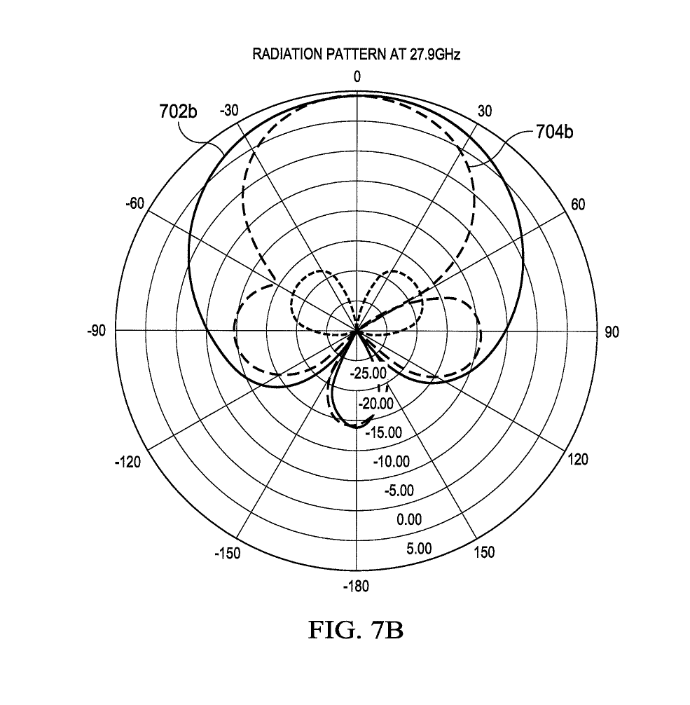

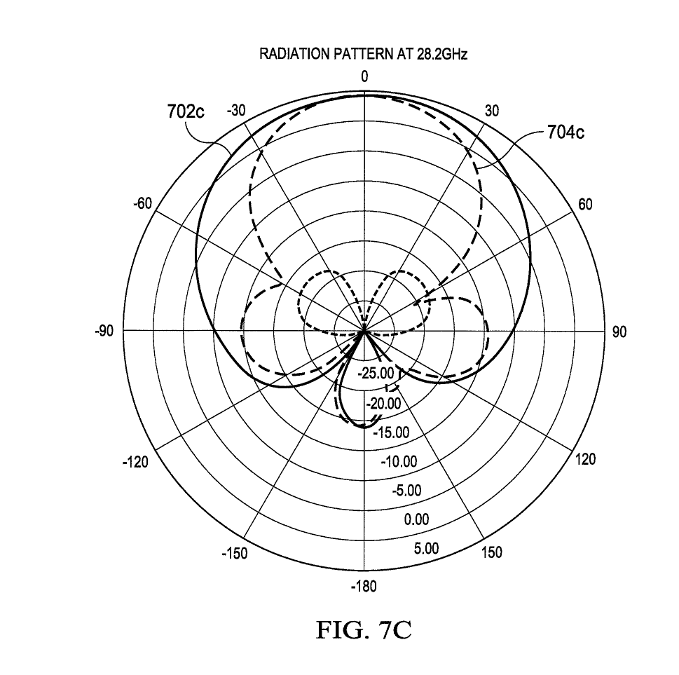

The standing wave nature of this configuration can also provide generally symmetric radiation patterns. Simulated radiation patterns at 27.6 GHz, 27.9 GHz, and 28.3 GHz for the patch sub-array 402 are shown in FIGS. 7A through 7C. In these figures, lines 702a-702c denote the H-plane radiation patterns, and lines 704a-704c denote the E-plane radiation patterns. As can be seen here, the E-plane and H-plane radiation patterns have excellent symmetry, with better than 25 dB cross-polarization suppression. A boresight gain of about 9 dBi to about 10 dBi can be realized throughout the bandwidth. The relatively wider H-plane beamwidth can provide excellent gain consistency when the whole array 400 is scanning ±30° in this plane (azimuth). The relatively narrower E-plane beamwidth can also be adequate to give reduced or minimal gain variation when the array is scanning ±10° in elevation. The selection of this sub-array 402 can ultimately provide high gain, reduced transmit/receive chain numbers, and minimal gain roll-off within the entire scanning scope.

Note that in this embodiment, a two-element series-fed patch configuration is used. However, each sub-array 402 could include three or more patch antenna elements 406 connected in series. The bandwidth and the H-plane beamwidth of such configurations can remain, the sub-array gain can increase, and the E-plane beamwidth can decrease, which may limit the scanning angle in elevation.

Each patch sub-array 402 by itself may be able to provide only linear polarization. To obtain circular polarization, an “image” sub-array can be used for a substantially orthogonal E-field. The slotted SIW sub-arrays 404 can be used to provide the substantially orthogonal E-field.

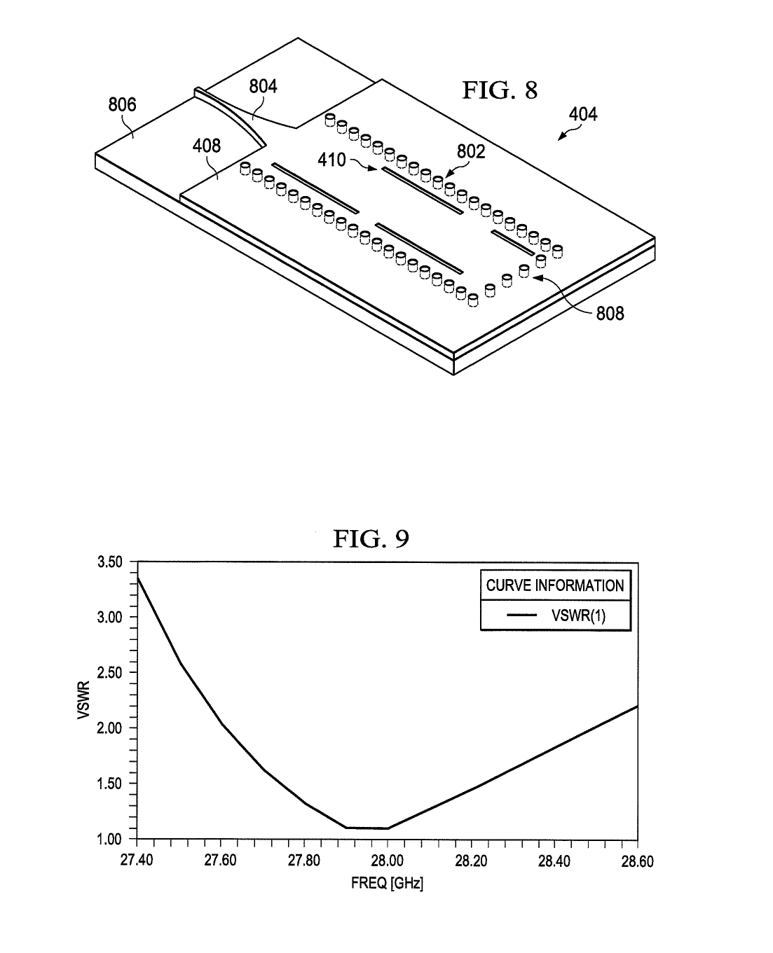

FIG. 8 illustrates an example embodiment of the slotted SIW sub-arrays 404. As shown in FIG. 8, the SIW sub-array 404 includes the conductive plate 408 with the slots 410. Filled vias 802 enclose a portion of the conductive plate 408, which is coupled to a microstrip-to-SIW transition line 804. The vias 802 can be formed through a printed circuit board or other substrate 806 and filled with any suitable material(s), such as by being plated with one or more conductive materials. In this example, four slots 410 are formed on the top surface of the waveguide for radiation, and one end 808 of the waveguide is enclosed by the vias 802 to reinforce the standing wave mode radiation.

The microstrip-to-SIW transition line 804 generally increases in width from the left side (where it may be coupled to a microstrip feed line) to the right side (where it connects to the conductive plate 408). This facilitates excitation of the structure using a microstrip feed line.

In this example, there are four slots 410 formed in the plate 408, although a different number of slots 410 could be used. Also, one of the slots 410 is shortened in length to compensate for the impact on far-field symmetry caused by the shorting walls at the end 808 of the waveguide. The width, length, and separations of the slots 410 can be fine-tuned so that the entire structure resonates at substantially the same frequency as the patch sub-arrays 402. The SIW sub-arrays 404 can be designed to provide almost identical radiation patterns as the patch sub-arrays 402 but with its E-plane and H-plane characteristics reversed.

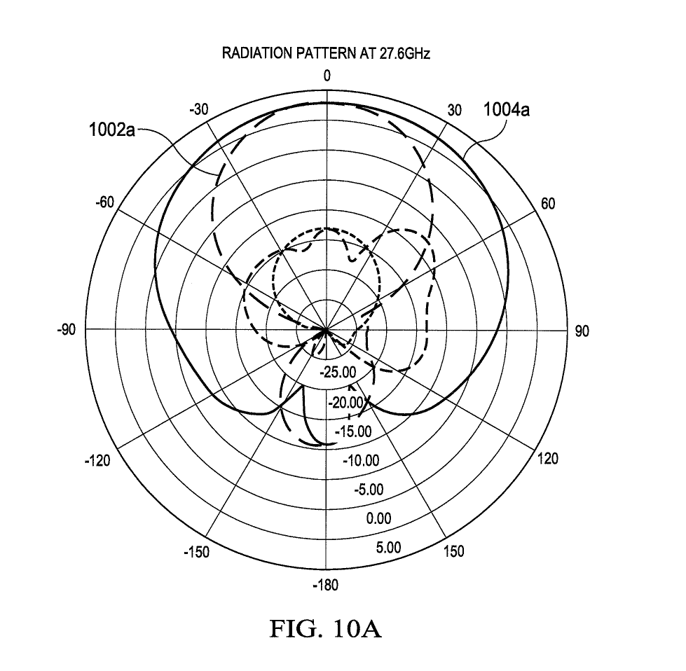

A simulated VSWR of the SIW sub-array 404 is shown in FIG. 9. As shown here, an 880 MHz bandwidth can be achieved with a 27.9 GHz center frequency. Note that the bandwidth of the SIW sub-array 404 is related to the number of slots 410, the separation of the slots 410, and the thickness of the substrate 806. Wider or narrower bandwidths can be achieved by tuning these or other parameters.

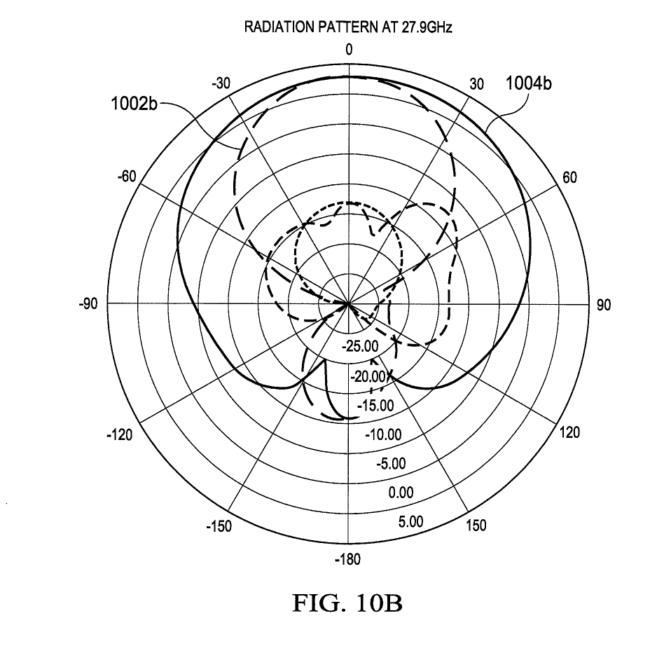

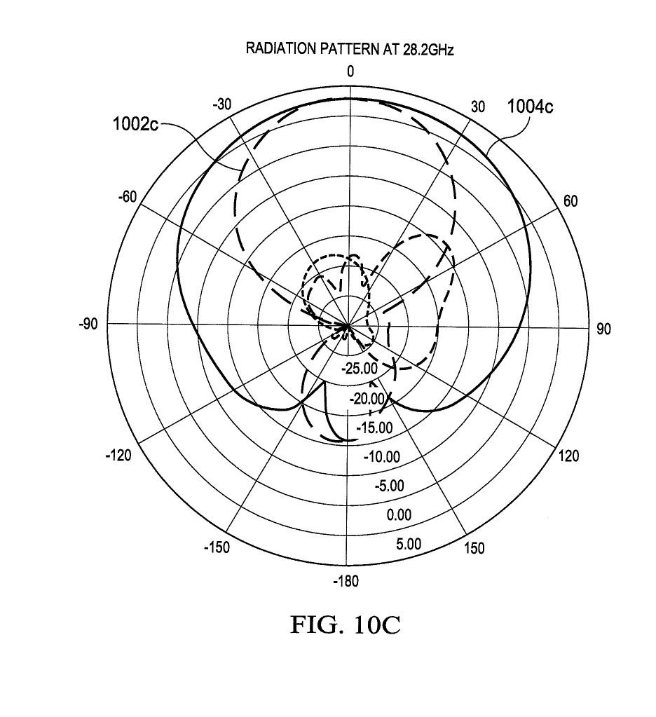

Simulated radiation patterns of the SIW sub-array 404 at 27.6 GHz, 27.9 GHz, and 28.2 GHz are shown in FIGS. 10A through 10C. In FIGS. 10A through 10C, lines 1002a-1002c denote the H-plane radiation patterns, and lines 1004a-1004c denote the E-plane radiation patterns. A boresight gain of about 8 dBi to about 9 dBi and excellent pattern symmetry can be realized throughout the bandwidth. Compared with the radiation patterns of the patch sub-array 402 shown in FIGS. 7A through 7C, the radiation patterns for the SIW sub-array 404 show excellent resemblance with co- and cross-polarizations interchanged. A relatively wider E-plane beam and a relatively narrower H-plane beam are achieved, which match the relatively wider H-plane beam and relatively narrower E-plane beam formed by the patch sub-array 402. When the two sub-arrays 402-404 are used together with quadrature phase offsets, a constantly-low axial ratio throughout the entire scanning area can be obtained.

Note that while the SIW sub-array 404 in FIG. 8 includes four slots 410, the SIW sub-array 404 could include any suitable number of slots 410. More than four slots 410 could be used to achieve higher gains but with reduced H-plane beamwidths. In this case, the SIW sub-arrays 404 could be paired with patch sub-arrays 402 each having more than two patch elements 406 to match their gain levels and beamwidths, although this can reduce the scanning angle in elevation.

As noted above, in the specific embodiment shown in FIG. 4, the antenna array 400 includes two-element patch sub-arrays 402 and four-slot SIW sub-arrays 404 that are interleaved for a total of 32 sub-arrays (16 patch sub-arrays 402 and 16 SIW sub-arrays 404). The number of phase shifters used for scanning can be reduced by a factor of two using the antenna array 400 compared with arrays without any sub-array employment. For even fewer phase shifters, embodiments with more than two elements 406 per patch sub-array 402 and more than four slots per SIW sub-array 404 can be used. The phase center of the patch sub-arrays 402 and the SIW sub-arrays 404 can be adjusted to remain in line to maintain constant axial ratios in the entire scanning scope.

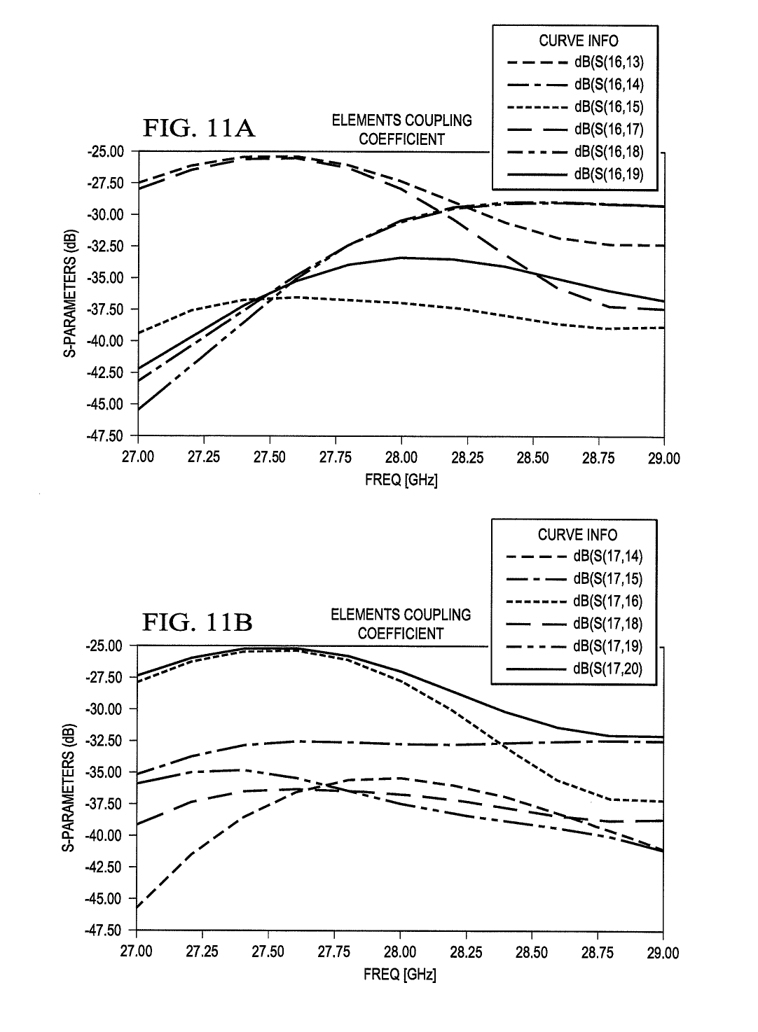

Simulated mutual couplings between adjacent ports of the antenna array 400 are shown in FIGS. 11A and 11D. In particular, port #16 (of the patch sub-array 402) and port #17 (of the SIW sub-array 404) are select for illustration. Coupling coefficients from the six adjacent ports are shown, which represent the highest possible coupling levels in this array setup. As seen here, the maximum coupling between sub-arrays 402-404 is smaller than −25 dB, which only occurs between the closest SIW and patch sub-array elements. Because embodiments of this disclosure adopt two different sub-arrays with substantially orthogonal mode orientations, this inherently reduces or prevents large mutual coupling from occurring.

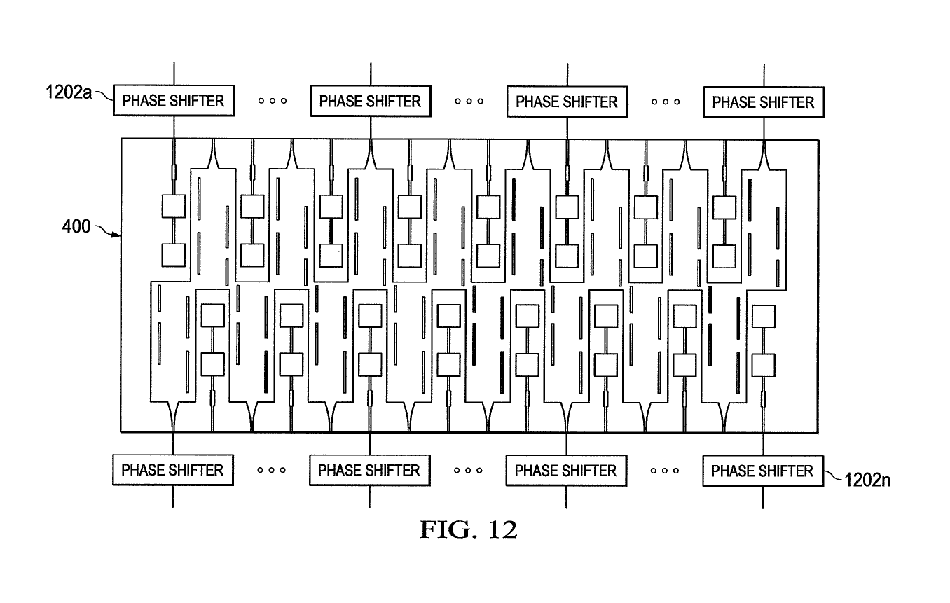

FIG. 12 illustrates one example use of the antenna array 400 in accordance with this disclosure. As shown in FIG. 12, the antenna array 400 is coupled to multiple phase shifters 1202a-1202n. Although not shown here for simplicity, each port #1-#32 of the antenna array 400 can be coupled to one of the phase shifters 1202a-1202n. Each of the phase shifters 1202a-1202n could also be coupled to a separate transceiver or other device or system. Each phase shifter 1202a-1202n can shift the phase of a signal sent to or received from the associated sub-array of the antenna array 400 by a desired amount. As described below, altering the phase shifts provided by the phase shifters 1202a-1202n allows the antenna array 400 to achieve different polarizations, thereby supporting configurable and reconfigurable polarizations of the antenna array 400. Each phase shifter 1202a-1202n includes any suitable structure for phase shifting a signal.

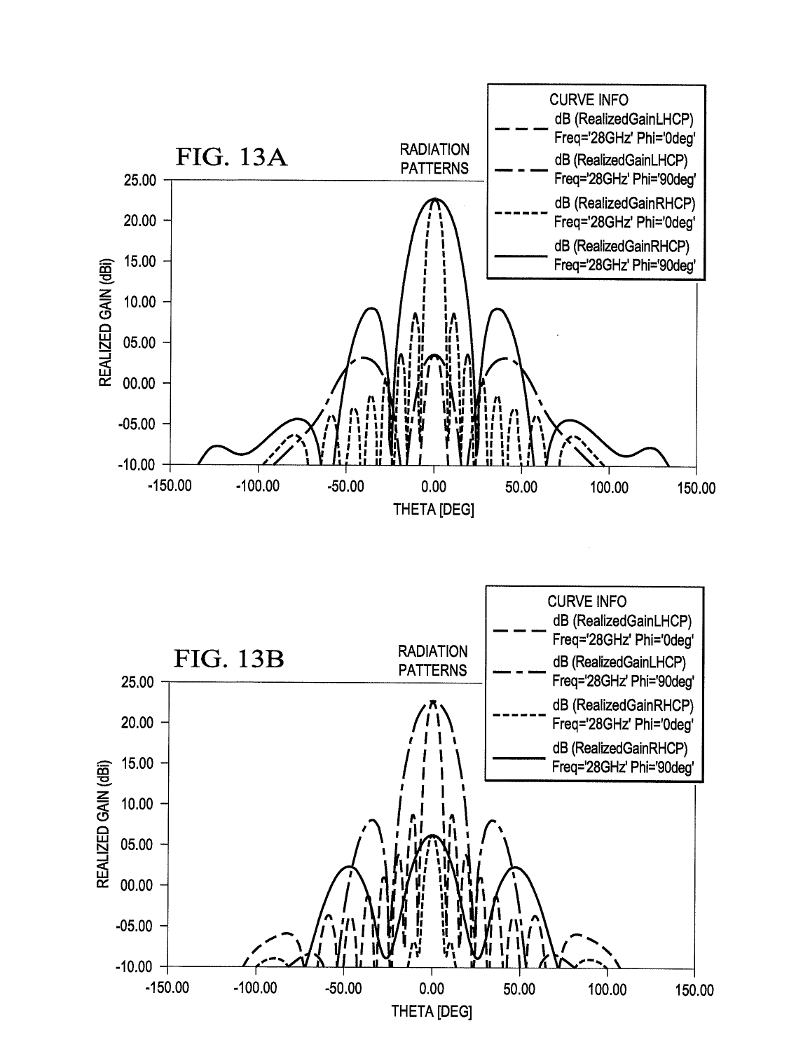

For broadside radiation (0° steering angle), 0° phase shifts can be applied between the patch sub-arrays 402 and the SIW sub-arrays 404. +90°/−90° phase shifts can be applied between the patch and SIW sub-arrays 402-404 to obtain instantaneous right-hand/left-hand circular polarizations (RHCP/LHCP). The obtained radiation patterns at 28 GHz are shown in FIGS. 13A and 13B for RHCP (FIG. 13A) and LHCP (FIG. 13B). Note that from 27.6 GHz to 28.2 GHz, the radiation patterns are very similar as expected from the sub-array radiations shown in FIGS. 7A-7C and FIGS. 10A-10C and are thus not included in FIGS. 13A-13B. Also, the array performance in the back ±30° is not shown since the gain there is well below −10 dBi. In this example, a 22.8 dBi/22.6 dBi RHCP/LHCP realized gain is obtained with LHCP/RHCP gain around 3.5 dBi/6 dBi, which corresponds to a 1.8 dB/2.6 dB axial ratio. Note that further phase tuning can provide better axial ratio values.

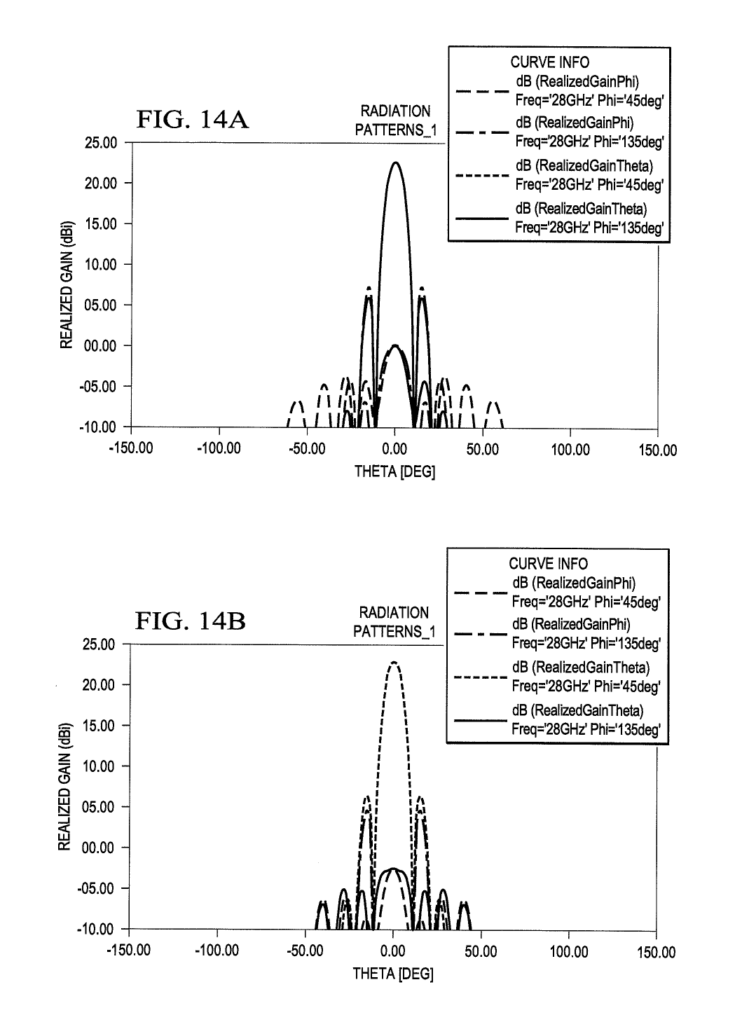

For linear polarizations, 0°/180° phase shifts can be applied between the patch and SIW sub-arrays 402-404. The results are shown in FIGS. 14A and 14B. The same gain levels as the CP modes are obtained with better than 20 dB cross-polarization suppression. Note that in the 2D plots in FIGS. 14A and 14B, although the beamwidths for the E-plane and the H-plane are the same, the overall beam is still an oval shape due to the dimensions of an aperture used with the array 400.

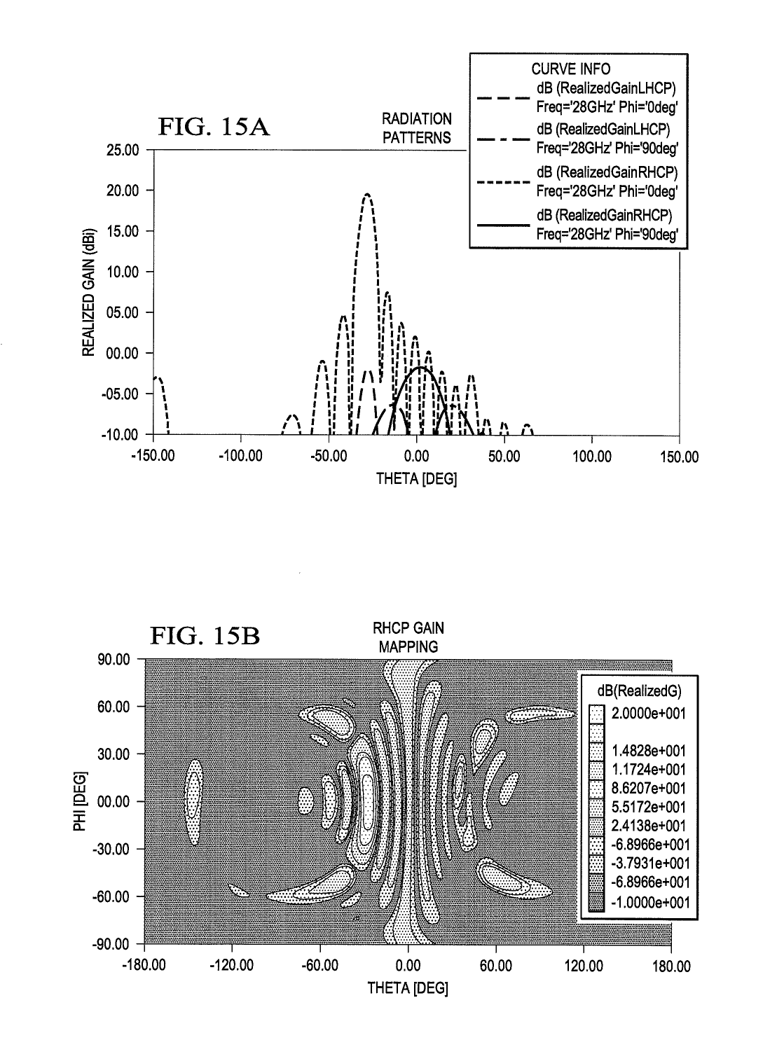

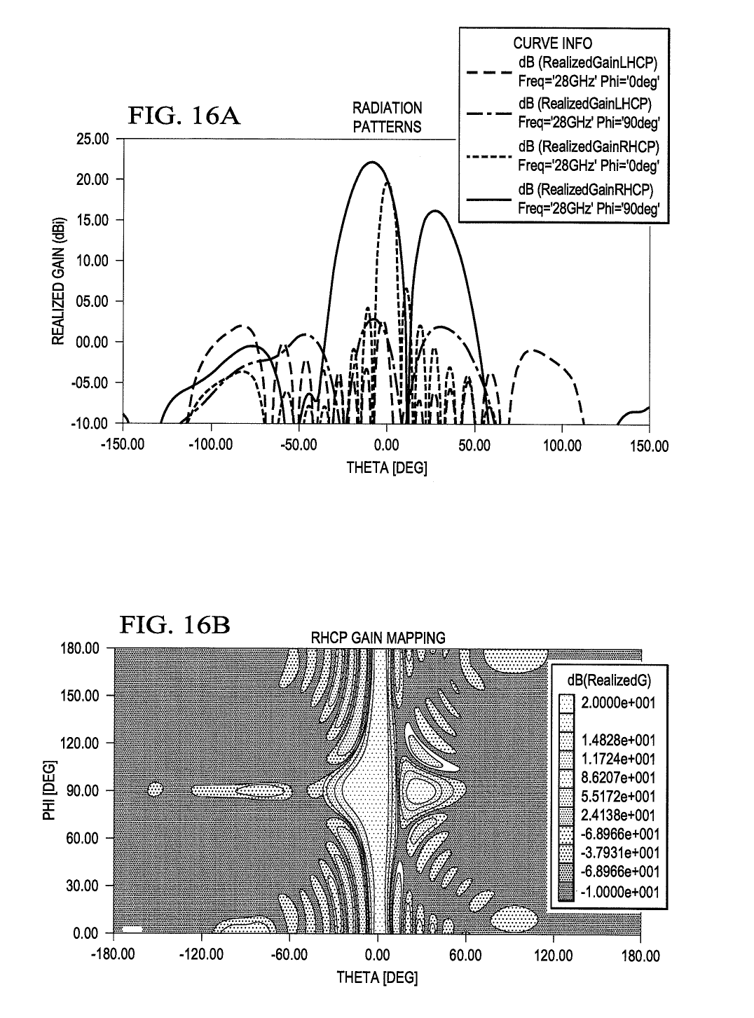

FIGS. 15A and 15B illustrate the array radiation patterns at 28 GHz with a −30° steering angle in the azimuth plane. For ±10° scanning in elevation with azimuth 0°, a phase shift can be applied between adjacent sub-array elements in the y-direction. In these embodiments, a ±90° phase step can be used for the ±10° beam steering in the elevation plane. Dual-CP or dual-LP can be achieved depending on the phase shifts between the two different sub-arrays 402-404. FIGS. 16A and 16B show a −10° RHCP beam steering. Here, a 22.3 dBi boresight gain is obtained with an excellent axial ratio (1.8 dB). A grating lobe shows up at elevation 15° due to the phase center distance between sub-arrays in the y-direction. Nevertheless, as seen from FIGS. 13A-13B, this embodiment readily achieves a 20° 3 dB beamwidth in elevation, which indicates that a ±10° elevation scanning requirement is fulfilled without actual scanning, which ultimately simplifies system level design requirements.

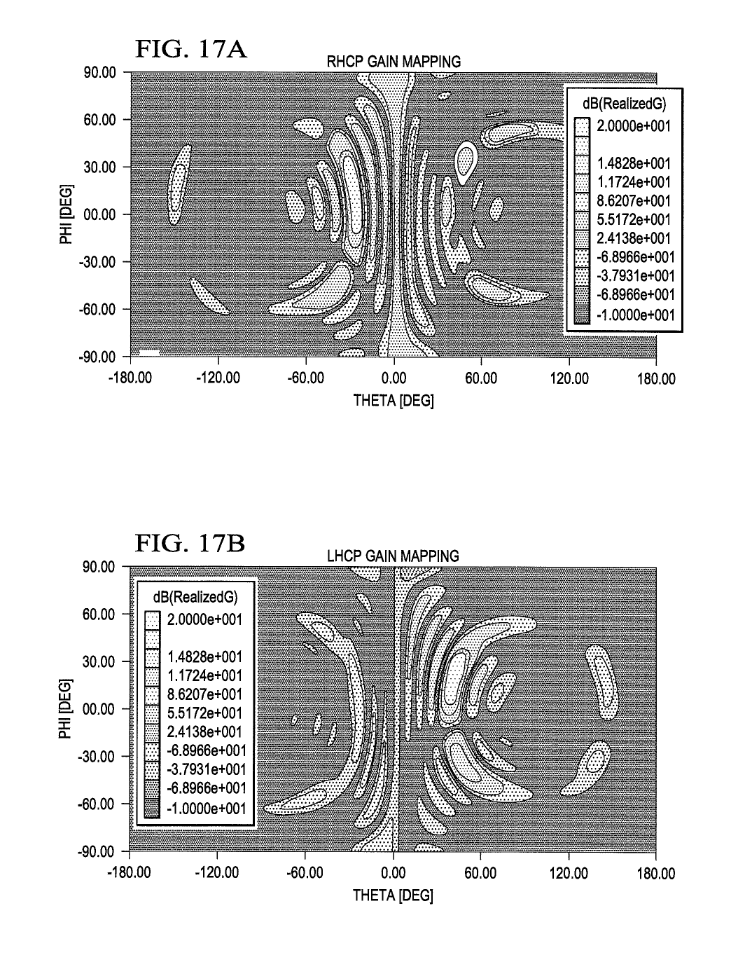

FIGS. 17A and 17B show circular polarization gain mappings of the antenna array 400 when the main beam is steered toward −30° in the azimuth plane and 10° in the elevation plane. The main beam (RHCP) achieves a 19.5 dBi gain at boresight with a 1.8 dB axial ratio. The cross-polarization (LHCP) lobes, however, shoot up outside the scanning scope (theta>30°).

Each component of the antenna array 400 could be formed using any suitable material(s), and the antenna array 400 could be fabricated in any suitable manner. For example, conductive material(s) can be deposited on a substrate (such as a PCB) and etched to form the various conductive structures of the antenna array 400. Particular fabrication techniques include standard PCB processing techniques, complementary metal oxide semiconductor (CMOS) fabrication techniques, and low temperature cofired ceramic (LTCC) fabrication techniques. The antenna array 400 described above could be used in any suitable devices or systems, including the eNBs 101-103 and UEs 111-116 of FIGS. 1 through 3.

Although FIGS. 4 through 17B illustrate one example of an antenna array 400 with a configurable polarization and related details, various changes may be made to FIGS. 4 through 17B. For example, while FIGS. 4 through 17B illustrate one particular implementation of the antenna array 400 using certain numbers of patch and SIW sub-arrays 402-404, the types, number, and arrangement of the sub-arrays are for illustration only. Moreover, figures showing radiation patterns, coupling coefficients, voltage standing wave ratios, and gain mappings and other diagrams that illustrate potential operations of the antenna array 400 are non-limiting. These figures are merely meant to illustrate possible functional aspects of specific embodiments of this disclosure. These figures are not meant to imply that all inventive devices operate in the specific manner shown in those figures.

Note that the above description has described the antenna array 400 as including patch and SIW sub-arrays. However, the antenna array 400 is not limited to use with just patch and SIW sub-arrays. In general, the antenna array 400 can include any antenna elements or sub-arrays, where different antenna elements or sub-arrays have substantially orthogonal E-field orientations. Other example embodiments of the antenna array 400 include those using dipole/monopole antenna elements and ring antenna element in different sub-arrays, dipole/monopole antenna elements and SIW antenna elements in different sub-arrays, and dipole/monopole antenna elements and patch antenna elements in different sub-arrays. Other embodiments with multiple antenna elements or antenna sub-arrays having a substantially orthogonal E-field orientation could be used.

Also note that while FIG. 4 shows that the different sub-arrays are interleaved, the multiple antenna elements or antenna sub-arrays of the antenna array could be arranged in any suitable manner. Possible arrangements include in line, interleaved, and criss-crossed, although other arrangements could also be used.

Although this disclosure has described numerous embodiments, various changes and modifications may be suggested to one skilled in the art. For example, note that various values given in the above descriptions (such as angle values, impedance bandwidths, AR bandwidths, and component dimensions) are approximate values only. Additionally, it is within the scope of this disclosure for elements from one or more embodiments to be combined with elements from one or more other embodiments. It is intended that this disclosure encompass such changes and modifications as fall within the scope of the appended claims.

What is claimed is:

1. An apparatus comprising:
an antenna array comprising multiple antenna elements arranged in multiple sub-arrays, the antenna elements arranged in at least two different types of sub-arrays;
wherein the at least two different types of sub-arrays have substantially orthogonal electric field (E-field) orientations.

2. The apparatus of claim 1, wherein the antenna elements are arranged in multiple patch sub-arrays and multiple substrate integrated waveguide (SIW) sub-arrays.

3. The apparatus of claim 2, wherein the patch sub-arrays are interleaved with the SIW sub-arrays.

4. The apparatus of claim 3, wherein each patch sub-array includes at least two patch antenna elements coupled in series.

5. The apparatus of claim 3, wherein each SIW sub-array includes a conductive plate and multiple slots in the conductive plate.

6. The apparatus of claim 2, wherein the SIW sub-arrays are configured to resonate at substantially a same frequency as the patch sub-arrays.

7. The apparatus of claim 1, wherein the antenna array is reconfigurable to support each of:
circular polarization;
dual linear polarization (LP);
instantaneous dual-circular and dual-linear polarizations; and
simultaneous dual-linear polarization dual-beam radiation.

8. The apparatus of claim 1, further comprising:
multiple phase shifters coupled to inputs of the sub-arrays, the phase shifters configured to alter phases of signals provided to the sub-arrays.

9. A system comprising:
an antenna array comprising multiple antenna elements arranged in multiple sub-arrays, the antenna elements arranged in at least two different types of sub-arrays, the at least two different types of sub-arrays having substantially orthogonal electric field (E-field) orientations; and
a transceiver configured to communicate wirelessly via the antenna.

10. The system of claim 9, wherein the antenna elements are arranged in multiple patch sub-arrays and multiple substrate integrated waveguide (SIW) sub-arrays.

11. The system of claim 10, wherein each patch sub-array includes at least two patch antenna elements coupled in series.

12. The system of claim 10, wherein each SIW sub-array includes a conductive plate and multiple slots in the conductive plate.

13. The system of claim 10, wherein the SIW sub-arrays are configured to resonate at substantially a same frequency as the patch sub-arrays.

14. The system of claim 9, wherein the antenna array is reconfigurable to support each of:
circular polarization;
dual linear polarization (LP);
instantaneous dual-circular and dual-linear polarizations; and
simultaneous dual-linear polarization dual-beam radiation.

15. The system of claim 9, further comprising:
multiple phase shifters coupled to inputs of the sub-arrays, the phase shifters configured to alter phases of signals provided to the sub-arrays.

16. The system of claim 9, wherein the system comprises a portion of a user equipment.

17. The system of claim 9, wherein the system comprises a portion of an eNodeB.

18. The system of claim 9, wherein the transceiver is configured to communicate via millimeter wave frequencies.

19. A method comprising:
at least one of: transmitting outgoing wireless signals and receiving incoming wireless signals using an antenna array;
wherein the antenna array comprises multiple antenna elements arranged in multiple sub-arrays, the antenna elements arranged in at least two different types of sub-arrays; and
wherein the at least two different types of sub-arrays have substantially orthogonal electric field (E-field) orientations.

20. The method of claim 19, wherein:
the antenna elements are arranged in multiple patch sub-arrays and multiple substrate integrated waveguide (SIW) sub-arrays;
the patch sub-arrays are interleaved with the SIW sub-arrays;
each patch sub-array includes at least two patch antenna elements coupled in series;
each SIW sub-array includes a conductive plate and multiple slots in the conductive plate; and
the SIW sub-arrays resonate at substantially a same frequency as the patch sub-arrays.
